(19) United States
(12) Patent Application Publication
(10) Pub. No.: US 2023/0279224 A1
(43) Pub. Date: Sep. 7, 2023

(54) SINGLE-LAYER STRUCTURE BASED ON RECYCLED POLYAMIDE

(71) Applicant: ARKEMA FRANCE, Colombes (FR)

(72) Inventors: Nicolas DUFAURE, Serquigny (FR); Florent DECHAMPS, Serquigny (FR); Thierry VASSELIN, Chiyoda-ku, Tokyo (JP); Sebastien VAUTIER, Colombes Cedex (FR); Pierre NIDERCORN, Grindorff-Bizing (FR)

(73) Assignee: ARKEMA FRANCE, Colombes (FR)

(21) Appl. No.: 18/004,335

(22) PCT Filed: Jul. 6, 2021
(86) PCT No.: PCT/FR2021/051237

§ 371 Date: Jan. 5, 2023

(30) Foreign Application Priority Data
Jul. 8, 2020 (FR) FR2007203
Sep. 25, 2020 (FR) FR2009763

(51) Int. Cl. C08L 77/02

(52) U.S. Cl. CPC C08L 77/02; C08L 2203/18; C08L 2207/20

(57) ABSTRACT

A single-layer tubular structure intended to convey fluids for a motor vehicle, formed by a layer formed by a composition predominantly including at least one catalyzed semi-crystalline aliphatic polyamide, the composition being formed by at least 30% by weight, in particular at least 50% by weight, of recycled material originating from at least one single-layer and/or multi-layer tube that was intended to convey fluids for a motor vehicle, the at least one single-layer and/or multi-layer tube being formed by a composition that predominantly includes at least one catalyzed or non-catalyzed polyamide, said at least one single-layer and/or multi-layer tube having been crushed, then at least recompounding with or without the addition of at least one catalyst to be able to be recycled, a simple one-off crushing being excluded.

The present invention relates to single-layer structures for conveying fluids for a motor vehicle based on recycled polyamides and to the method for preparing them from a single-layer and/or multi-layer tube that was intended to convey said fluids for a motor vehicle.

Every year, several million motor vehicles reach the end of their life across the globe. An end-of-life vehicle (ELV) contains numerous toxic and polluting products (liquids or solids): drain oil, battery, air conditioning fluid, explosive airbag components, etc. When processed under the wrong conditions, this waste can lead to soil and water pollution, as well as accidents. ELVs are therefore considered to be hazardous waste.

A large number of the vehicle's components can be recovered and recycled, in the form of spare parts or raw materials. Parts intended for re-use (headlights, indicators, motor, radiator, starter motor, hood, wings, doors, etc.) are removed and stored in order to be resold.

The carcass and parts that cannot be recycled (ferrous and non-ferrous metals, plastics, glass, rubber, etc.) are crushed in order to be recovered or placed in landfill.

European Directive 2000/53/EC relating to end-of-life vehicles sets a reuse and recovery target of 95% by weight per vehicle starting in 2015.

Only 5% of residual waste should remain, that is to say waste that is not able to be treated under the present technical and economic conditions and that will be incinerated or evacuated to specific storage centers.

The 95% reused and recovered are subject to:
Energy recovery: use of waste (oils, tires, plastics, etc.) as energy production means, by direct incineration with or without other waste;
Material recovery: Reuse or repurpose: new use of a part that retains the same use and is not converted, or Recycling: operation aimed at introducing materials from waste into the production cycle, by fully or partially replacing a virgin material.

A motor vehicle contains a large number of pipes especially pipes for transporting fluids such as air, oil (for example to cool the automatic gearbox, “TOC” for Transmission Oil Cooler), water, a urea solution, a glycol-based coolant, a fuel such as gasoline, in particular bio-gasoline or diesel, in particular bio-diesel, or hydrogen.

These pipes can be single-layer and/or multi-layer tubular structures, in particular based on polyamide(s).

When the motor vehicle has reached the end of life, some pipes present therein may be too degraded to be able to be reused as such, in the form of a tube, without risk or without this resulting in functional properties that are too degraded.

Indeed, the tubes, especially under the engine hood, are fitted in a severe thermo-oxidative environment owing to the heat released by the engine that can typically reach 150° C. and the presence of air and therefore of oxygen. Each 10° C. increase in temperature typically results in the service life of the tubes being halved, as well as the degradation of certain additives of said tubes such as stabilizers.

Furthermore, a pipe for conveying a fuel, for example a polyamide pipe that contains a plasticizer, has lost the majority of its plasticizer when it reaches the end of life and the polyamide initially present therein can be partially depolymerized and/or degraded and has lost most of its stabilizers, which prevents it from being reused safely.

Until now, the end-of-life automotive pipe is not reused and is often incinerated, but this then contributes to climate change, a reduction in which is becoming one of the major challenges of the 21st century

Moreover, several vehicle manufacturers have the medium to long term objective of recycling 100% of the vehicles that they manufacture so as to achieve zero environmental impact.

Consequently, supplying recycled pipes to these manufacturers becomes essential and then makes it possible to reduce the quantity of pipes to be discarded or incinerated.

The present invention therefore relates to a single-layer tubular structure intended to convey fluids for a motor vehicle, in particular air, oil, water, urea solution, a glycol-based coolant, or a fuel such as gasoline, in particular alcohol-based gasoline, bio-gasoline or diesel, in particular bio-diesel, or hydrogen, formed by:
at least one layer (1) formed by a composition predominantly comprising at least one catalyzed semi-crystalline aliphatic polyamide, said composition being formed by at least 30% by weight of recycled material, in particular at least 50% of recycled material originating from a single-layer and/or multi-layer tube that was intended to convey fluids for a motor vehicle, in particular as defined hereinbefore, said tube being formed by a composition that predominantly comprises at least one catalyzed or non-catalyzed polyamide, said tube having been crushed and then at least recompounded with or without the addition of at least one catalyst in order to be able to be recycled,
a simple one-off crushing being excluded from the different treatments.

The inventors therefore surprisingly found that a layer based on catalyzed semi-crystalline polyamide and formed by at least 30%, in particular at least 50% of recycled material made it possible to form a single-layer tubular structure capable of conveying a fluid of a motor vehicle, in particular air, oil, water, a urea solution, a glycol-based cooling liquid, or a fuel such as gasoline, in particular bio-gasoline or diesel, in particular bio-diesel, or hydrogen, regardless of the type of fluid originally conveyed by the recycled single-layer and/or multi-layer tube that forms the single layer, layer in contact with the conveyed fluid, said single-layer structure having, against all expectations, much better properties than those of the same tubular structure, the layer (1) of which, based on catalyzed semi-crystalline polyamide and formed by at least 30, in particular at least 50% of recycled material, simply comes from crushed material.

In one embodiment, said composition of is formed by at least 50% of recycled material originating from a single-layer and/or multi-layer tube that was intended to convey fluids for a motor vehicle.

In another embodiment, said at least one single-layer and/or multi-layer tube is formed by a composition that predominantly comprises at least one catalyzed polyamide, said at least one single-layer and/or multi-layer tube having been crushed and then at least recompounded without the addition of a catalyst in order to be able to be recycled.

In yet another embodiment, said at least one single-layer and/or multi-layer tube is formed by a composition that predominantly comprises at least one catalyzed polyamide, said at least one single-layer and/or multi-layer tube having been crushed and then at least recompounded with the addition of a catalyst in order to be able to be recycled.

A polyamide-based layer means that there is at least 50% by weight of polyamides in the layer (1).

The term “fluid” refers to a gas or a liquid used in the vehicle, in particular air, oil, water, a urea solution, a glycol-based coolant, or a fuel such as gasoline, in particular alcohol-based gasoline, bio-gasoline or diesel, in particular bio-diesel, or hydrogen.

Advantageously, said fluid refers to fuels, in particular gasoline, in particular alcohol-based gasoline, bio-gasoline or diesel, in particular bio-diesel.

The term “gasoline” refers to a hydrocarbon mixture from the distillation of petroleum to which additives or alcohols such as methanol and ethanol can be added, the alcohols being the predominant components in certain cases.

The expression “alcohol-based gasoline” refers to a gasoline in which methanol or ethanol have been added. It also refers to an E95-type gasoline that does not contain any petroleum distillation product.

The expression “polyamide-based” means at least 50% by weight of polyamide in the layer.

The expression “a composition predominantly comprising at least one polyamide . . . ” means at least 50% by weight of said polyamide in the composition.

As already specified hereinbefore, when the motor vehicle has reached the end of life, some pipes present therein may be too degraded to be able to be reused as such, in the form of a tube, without risk or without this resulting in functional properties that are too degraded.

The tube to be reused or in other words to be recycled (single-layer and/or multi-layer) is therefore removed from the motor vehicle and first is crushed and then this crushed tube is recompounded, that is to say that the homogenate is again inserted at least one into an extruder, in particular of the twin-screw co-rotating type, or of the co-kneader type (Buss), where the homogenate is mixed again by melting, with or without the addition of at least one catalyst. The molten material comes out of the extruder in strands that are cooled and cut into granules.

If the composition of the layer (1) is formed by less than 100% recycled material, it is then necessary to add a polyamide (identical or different) of non-recycled origin to the material to be recycled, and this can be done when passing through the extruder at least once or else by prior compounding of the granules hereinbefore obtained with said polyamide of non-recycled origin.

Regarding the Layer (1)

The layer (1) is formed by a composition comprising predominantly at least one catalyzed semi-crystalline aliphatic polyamide, said composition being formed by at least 30% by weight, in particular at least 50% of recycled material originating from a single-layer and/or multi-layer tube that was intended to convey fluids for a motor vehicle, said tube being formed by a composition that predominantly comprises at least one catalyzed or non-catalyzed polyamide, said tube having been crushed and then at least recompounded with or without the addition of at least one catalyst in order to be able to be recycled.

The addition of the catalyst depends on whether or not said or one catalyst is present in the single-layer and/or multi-layer tube that was intended to convey fluids for a motor vehicle and is therefore used.

In a first variant, said layer (1) is formed by a composition comprising:
at least 30% of a catalyzed polyamide originating from a single-layer and/or multi-layer tube formed by a composition that predominantly comprises at least one non-catalyzed polyamide and which has been recompounded at least once after crushing with the addition of a catalyst in a proportion of 0.005% to 0.5% by weight of a catalyst relative to the total weight of said polyamide plus added catalyst originating from said tube,
the remainder to 100% being an optionally catalyzed semi-crystalline polyamide, in particular catalyzed,
the proportion of catalyst in the composition being from 0.005% to 0.5% by weight relative to the total weight of the composition.

In a first embodiment of the first variant, said layer (1) is formed by a composition comprising:
at least 40% of said catalyzed polyamide originating from said recompounded tube with the addition of catalyst,
the remainder to 100% being a catalyzed semi-crystalline polyamide,
the proportion of catalyst in the composition being from 0.005% to 0.5% by weight relative to the total weight of the composition.

In a second embodiment of the first variant, said layer (1) is formed by a composition comprising:
at least 50% of said catalyzed polyamide originating from said recompounded tube with the addition of catalyst,
the remainder to 100% being a catalyzed semi-crystalline polyamide,
the proportion of catalyst in the composition being from 0.005% to 0.5% by weight relative to the total weight of the composition.

In a third embodiment of the first variant, said layer (1) is formed by a composition comprising:
at least 60% of said catalyzed polyamide originating from said recompounded tube with the addition of catalyst,
the remainder to 100% being a catalyzed semi-crystalline polyamide,
the proportion of catalyst in the composition being from 0.005% to 0.5% by weight relative to the total weight of the composition.

In a fourth embodiment of the first variant, said layer (1) is formed by a composition comprising:
at least 70% of said catalyzed polyamide originating from said recompounded tube with the addition of catalyst,
the remainder to 100% being a catalyzed semi-crystalline polyamide,
the proportion of catalyst in the composition being from 0.005% to 0.5% by weight relative to the total weight of the composition.

In a fifth embodiment of the first variant, said layer (1) is formed by a composition comprising:
at least 80% of said catalyzed polyamide originating from said recompounded tube with the addition of catalyst,
the remainder to 100% being a catalyzed semi-crystalline polyamide,
the proportion of catalyst in the composition being from 0.005% to 0.5% by weight relative to the total weight of the composition.

In a sixth embodiment of the first variant, said layer (1) is formed by a composition comprising:
at least 90% of said catalyzed polyamide originating from said recompounded tube with the addition of catalyst,
the remainder to 100% being a catalyzed semi-crystalline polyamide,
the proportion of catalyst in the composition being from 0.005% to 0.5% by weight relative to the total weight of the composition.

In a seventh embodiment of the first variant, said layer (1) is formed by a composition comprising:
100% of said catalyzed polyamide originating from said recompounded tube with the addition of catalyst,
the proportion of catalyst in the composition being from 0.005% to 0.5% by weight relative to the total weight of the composition.

Advantageously, said composition of the layer (1) in this first variant may comprise other constituents such as impact modifiers, plasticizers additives with the exception of catalysts.

Advantageously, said composition of the layer (1) in this first variant lacks plasticizer and/or impact modifier.

Advantageously, said layer (1) is formed by a composition formed by the constituents as defined for each embodiment of the first variant.

Advantageously, in this first variant, the recompounding number is comprised from 1 to 10, in particular from 1 to 5, especially the recompounding number is 1, 2, 3, 4 or 5, in particular 1, 2 or 3.

In a second variant, said layer (1) is formed by a composition comprising:
at least 30% of a catalyzed polyamide originating from a single-layer and/or multi-layer tube formed by a composition that predominantly comprises at least one catalyzed polyamide and which has been recompounded at least once after crushing without the addition of a catalyst,
the proportion by weight of catalyst being between 0.005% and 0.5% relative to the total weight of said polyamide and of the catalyst,
the remainder to 100% being an optionally catalyzed semi-crystalline polyamide, in particular catalyzed,
the proportion of catalyst in the composition being from 0.005% to 0.5% by weight relative to the total weight of the composition.

In a first embodiment of the second variant, said layer (1) is formed by a composition comprising:
at least 40% of said catalyzed polyamide originating from said recompounded tube,
the remainder to 100% being a catalyzed semi-crystalline polyamide,
the proportion of catalyst in the composition being from 0.005% to 0.5% by weight relative to the total weight of the composition.

In a second embodiment of the second variant, said layer (1) is formed by a composition comprising:
at least 50% of said catalyzed polyamide originating from said recompounded tube,
the remainder to 100% being a catalyzed semi-crystalline polyamide,
the proportion of catalyst in the composition being from 0.005% to 0.5% by weight relative to the total weight of the composition.

In a third embodiment of the second variant, said layer (1) is formed by a composition comprising:
at least 60% of said catalyzed polyamide originating from said recompounded tube,
the remainder to 100% being a catalyzed semi-crystalline polyamide,
the proportion of catalyst in the composition being from 0.005% to 0.5% by weight relative to the total weight of the composition.

In a fourth embodiment of the second variant, said layer (1) is formed by a composition comprising:
at least 70% of said catalyzed polyamide originating from said recompounded tube,
the remainder to 100% being a catalyzed semi-crystalline polyamide,
the proportion of catalyst in the composition being from 0.005% to 0.5% by weight relative to the total weight of the composition.

In a fifth embodiment of the second variant, said layer (1) is formed by a composition comprising:
at least 80% of said catalyzed polyamide originating from said recompounded tube,
the remainder to 100% being a catalyzed semi-crystalline polyamide,
the proportion of catalyst in the composition being from 0.005% to 0.5% by weight relative to the total weight of the composition.

In a sixth embodiment of the second variant, said layer (1) is formed by a composition comprising:

at least 90% of said catalyzed polyamide originating from said recompounded tube,
the remainder to 100% being a catalyzed semi-crystalline polyamide,
the proportion of catalyst in the composition being from 0.005% to 0.5% by weight relative to the total weight of the composition.

In a seventh embodiment of the second variant, said layer (1) is formed by a composition comprising:
100% of said catalyzed polyamide originating from said recompounded tube,
the proportion of catalyst in the composition being from 0.005% to 0.5% by weight relative to the total weight of the composition.

Advantageously, the initial inherent viscosity of the polyamide of said tube of one of the embodiments of one of the two variants hereinbefore, before use as determined according to ISO 307:2007 in m-cresol at 20° C. is from 1.3 dl/g to 1.6 dl/g.

Said tube has therefore never been used.

Advantageously, the inherent viscosity of the polyamide of said used tube of one of the embodiments of one of the two variants hereinbefore, before recycling as determined according to ISO 307:2007 in m-cresol at 20° C. is from 0.8 dl/g to 1.6 dl/g.

Advantageously, the inherent viscosity of the composition of the layer (1) after recycling said tube, that is to say after crushing and recompounding with or without catalyst, as determined according to ISO 307:2007 in m-cresol at 20° C. is from 1.3 dl/g to 1.6 dl/g.

Advantageously, degassing is carried out during at least one compounding, even more advantageously the degassing is located just after the melting zone in an extruder.

In one embodiment, the degassing is weak, which means that the degassing is comprised from −50 mmHg to −150 mmHg.

In another embodiment, the degassing is strong, which means that the degassing is comprised from −550 mmHg to −750 mmHg.

Advantageously, the inherent viscosity of the composition of the layer (1) after recycling with degassing of said tube, that is to say after crushing and recompounding with or without catalyst, and degassing, as determined according to ISO 307:2007 in m-cresol at 20° C. is from 1.3 dl/g to 1.6 dl/g.

Advantageously, said composition of the layer (1) in this second variant may comprise other constituents such as impact modifiers, plasticizers additives with the exception of catalysts.

Advantageously, said composition of the layer (1) in this second variant lacks plasticizer and/or impact modifier.

Advantageously, said layer (1) is formed by a composition formed by the constituents as defined for each embodiment of the second variant.

Advantageously, in this second variant, the recompounding number is from 1 to 10, in particular from 1 to 5, especially 1, 2, 3, 4 or 5.

Whether in the first or second variant, the recycled polyamide may be identical to or different from the semi-crystalline aliphatic polyamide.

This means that the recycled polyamide can be aliphatic or semi-aromatic for example.

Advantageously, the recycled polyamide is aliphatic, more advantageously it is semi-crystalline aliphatic and even more advantageously, it has the same number of carbon atoms per nitrogen atom as the semi-crystalline aliphatic polyamide with which it is mixed when said recycled polyamide does not make up 100%.

In one embodiment, the predominant semi-crystalline aliphatic polyamide of layer (1) has a crystallization enthalpy 25 J/g, preferentially 40 J/g, in particular 45 J/g as determined by DSC according to ISO standard 11357-3:2013 at a heating rate of 20K/min.

The nomenclature used to define the polyamides is described in ISO standard 1874-1:2011 “Plastics—Polyamide (PA) Molding And Extrusion Materials—Part 1: Designation” and is well known to a skilled person.

The term “polyamide” according to the invention refers equally to a homopolyamide and to a copolyamide.

The expression “semi-crystalline aliphatic polyamide” in the sense of the invention throughout the description refers to aliphatic polyamides that have a melting temperature (Tm) and an enthalpy of fusion ΔH>25 J/g, in particular >40 J/g, especially >45 J/g, as well as a glass-transition temperature (Tg) as determined by DSC according to ISO standards 11357-1:2016 and 11357-2 and 3:2013 at a heating rate of 20 K/min.

Said at least one semi-crystalline aliphatic polyamide is obtained from the polycondensation of at least one lactam, or from the polycondensation of at least one amino acid, or from the polycondensation of at least one diamine Xa with at least one dicarboxylic acid Yb.

When said at least one semi-crystalline aliphatic polyamide is obtained from the polycondensation of at least one lactam, said at least one lactam may be selected from a C6 to C18 lactam, preferentially C10 to C18, more preferentially C10 to C12. A C6 to C12 lactam is especially caprolactam, decanolactam, undecanolactam, and lauryllactam.

Throughout the description, the expressions Cn to Cm used for the lactams, amino acids, diamine Xa and dicarboxylic acid Yb correspond to the average number of carbon atoms per nitrogen atom.

When said at least one semi-crystalline aliphatic polyamide is obtained from the polycondensation of at least one lactam, it may therefore comprise a single lactam or several lactams.

Advantageously, said at least one semi-crystalline aliphatic polyamide is obtained from the polycondensation of a single lactam and said lactam is selected from lauryllactam and undecanolactam, advantageously lauryllactam.

When said at least one semi-crystalline aliphatic polyamide is obtained from the polycondensation of at least one amino acid, said at least one amino acid can be selected from a C6 to C18, preferentially C10 to C18, more preferentially C10 to C12 amino acid.

A C6 to C12 amino acid is especially 6-aminohexanoic acid, 9-aminononanoic acid, 10-aminodecanoic acid, 10-aminoundecanoic acid, 12-aminododecanoic acid and 11-aminoundecanoic acid and derivatives thereof, especially N-heptyl-11-aminoundecanoic acid.

When said at least one semi-crystalline aliphatic polyamide is obtained from the polycondensation of at least one amino acid, it may therefore comprise a single amino acid or several amino acids.

Advantageously, said semi-crystalline aliphatic polyamide is obtained from the polycondensation of a single amino acid and said amino acid is selected from 11-aminoundecanoic acid and 12-aminododecanoic acid, advantageously 11-aminoundecanoic acid.

When said at least one semi-crystalline aliphatic polyamide is obtained from the polycondensation of at least one C4-C36, preferentially C5-C18, preferentially C5-C12, more preferentially C10-C12 diamine Xa, with at least one C4-C36, preferentially C6-C18, preferentially C6-C12, more preferentially C10-C12 diacid Yb, then said at least one diamine Xa is an aliphatic diamine and said at least one diacid Yb is an aliphatic diacid.

The diamine may be linear or branched. Advantageously, it is linear.

Said at least one C4-C36 diamine Xa can be in particular selected from 1,4-butanediamine, 1,5-pentamethylenediamine, 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine, octadecenediamine, eicosanediamine, docosanediamine and the diamines obtained from fatty acids.

Advantageously, said at least one diamine Xa is C5-C18 and selected from 1,5-pentamethylenediamine, 1,6-hexamethylenediamine, 1,7-heptamethylenediamine, 1,8-octamethylenediamine, 1,9-nonamethylenediamine, 1,10-decamethylenediamine 1,11-undecamethylenediamine, 1,12-dodecamethylenediamine, 1,13-tridecamethylenediamine, 1,14-tetradecamethylenediamine, 1,16-hexadecamethylenediamine and 1,18-octadecamethylenediamine.

Advantageously, said at least one C5 to C12 diamine Xa is in particular selected from 1,5-pentamethylenediamine, 1,6-hexamethylenediamine, 1,7-heptamethylediamine, 1,8-octamethylediamine, 1,9-nonamethylenediamine, 1,10-decamethylenediamine, 1,11-undecamethylenediamine, 1,12-dodecamethylenediamine.

Advantageously, said at least one C6 to C12 diamine Xa is in particular selected from 1,6-hexamethylenediamine, 1,7-heptamethylenediamine, 1,8-octamethylenediamine, 1,9-nonamethylenediamine, 1,10-decamethylenediamine, 1,11-undecamethylenediamine, 1,12-dodecamethylenediamine.

Advantageously, the diamine Xa used is a C10 to C12 diamine, in particular selected from 1,10-decamethylenediamine, 1,11-undecamethylenediamine, 1,12-dodecamethylenediamine.

Said at least one C4 to C36 dicarboxylic acid Yb may be selected from succinic acid, glutaric acid, adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, and diacids obtained from fatty acids.

The diacid may be linear or branched. Advantageously, it is linear.

Advantageously, said at least one dicarboxylic acid Yb is C6 to C18 and is selected from adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid.

Advantageously, said at least one dicarboxylic acid Yb is C6 to C12 and is selected from adipic acid, suberic acid, azelaic acid, sebacic acid, undecanedioic acid, and dodecanedioic acid.

Advantageously, said at least one dicarboxylic acid Yb is C10 to C12 and is selected from sebacic acid, undecanedioic acid and dodecanedioic acid.

When said semi-crystalline aliphatic polyamide is obtained from the polycondensation of at least one diamine Xa with at least one dicarboxylic acid Yb, it may therefore comprise a single diamine or several diamines and a single dicarboxylic acid or several dicarboxylic acids.

Advantageously, said semi-crystalline aliphatic polyamide is obtained from the polycondensation of a single diamine Xa with a single dicarboxylic acid Yb.

The expression “predominantly comprising at least one catalyzed semi-crystalline aliphatic polyamide” means that said composition of the layer (1) comprises at least 50% by weight of at least one catalyzed semi-crystalline aliphatic polyamide relative to the total weight of said composition. The catalyst may originate either from a non-recycled semi-crystalline aliphatic polyamide which was added, or from a recycled single-layer and/or multi-layer tube that is already catalyzed and recrushed and recompounded without the addition of catalyst, or from a non-catalyzed recycled single-layer and/or multi-layer tube recrushed and recompounded with the addition of catalyst.

Advantageously, said composition of the layer (1) comprises at least 60% by weight, especially at least 70% by weight, in particular at least 80% by weight, more particularly at least 90% by weight of at least one semi-crystalline aliphatic polyamide relative to the total weight of said composition.

The recycled material can come from a single layer and/or multilayer tube, said single layer and/or multilayer tubes having been intended for transporting fluids for a motor vehicle. Said tube is therefore a used tube, that is to say that it has been used for at least one year to convey said fluid defined hereinbefore or that it has been used for less than one year but that the car containing it has been scrapped. Said single layer tube consists of a composition comprising a semi-crystalline aliphatic polyamide and optionally impact modifiers and/or additives and/or plasticizers and/or antistatic fillers.

Said multilayer tube comprises at least one layer consisting of a composition comprising a semi-crystalline aliphatic polyamide and optionally impact modifiers and/or additives. It may therefore comprise other layers consisting of a different thermoplastic polymer to a semi-crystalline aliphatic polyamide, such as for example a polypropylene, a semi-aromatic polyamide or an ethylene vinyl alcohol polymer (EVOH).

It is very obvious that the single-layer tube can also be a mixture of single-layer tubes, that is for example two types of single-layer tubes each formed by a different semi-crystalline aliphatic polyamide, for example a PA11 and a PA12.

It is also very obvious that the multi-layer tube can also be a mixture of different types of multi-layer tubes, provided that at least one of the layers of one of the types of multi-layer tube consists of a polyamide, especially a semi-crystalline aliphatic polyamide.

Said single-layer and/or multi-layer tube intended to convey fluids for a motor vehicle and which is therefore used undergoes different treatments in order to be able to be recycled:
it is crushed and recompounded, that is to say that after crushing, the crushed particles are fed into an extruder,
A simply crushed tube is therefore excluded from said used single-layer and/or multi-layer tube which was intended for conveying a fluid for a motor vehicle.

Advantageously, the Tm of the predominant semi-crystalline aliphatic polyamide of the layer (1) is ≤225° C., in particular ≤200° C., as determined according to ISO 11357-3: 2013, at a heating rate of 20 K/min.

In one embodiment, the fluid conveyed by said single-layer and/or multi-layer tube is different from that of said single-layer tubular structure.

This means that if the single-layer and/or multi-layer tube conveyed a fluid such as air, said single-layer tubular structure may be intended to convey gasoline or else, that if the single-layer and/or multi-layer tube conveyed a fluid such as alcohol-based gasoline, said single-layer tubular structure may be intended to convey diesel.

In another embodiment, the fluid conveyed by said single-layer and/or multi-layer tube is the same as that of said single-layer tubular structure.

This means that if the single-layer and/or multi-layer tube conveyed a fluid such as gasoline, said single-layer tubular structure may be intended to convey gasoline provided that the gasoline of the single-layer and/or multi-layer tube and of said single-layer tubular structure is the same, for example, alcohol-based gasoline.

Advantageously, the recycled material originates from a single-layer tube.

Advantageously, the recycled material originates from a multi-layer tube.

Advantageously, the recycled material originates from a single-layer tube formed by a composition comprising only a polyamide 11 (PA11) or a polyamide 12 (PA12), in particular a polyamide 11 (PA11).

In one embodiment, said composition of the layer (1) comprises at least 60% by weight, especially at least 70% by weight, especially at least 80% by weight, in particular at least 90% by weight, more particularly at least 95% of recycled material.

In one embodiment, said composition of the layer (1) is formed by at least 60% by weight, especially at least 70% by weight, especially at least 80% by weight, in particular at least 90% by weight, more particularly at least 95% of recycled material.

Recycled Used Single-Layer or Multi-Layer Tube

In a first variant, said tube which was intended to convey a fluid for a motor vehicle is a single-layer, non-catalyzed which is then crushed and recompounded with the addition of catalyst.

In one embodiment of this first variant, the polyamide of said tube is an aliphatic or aromatic polyamide, in particular an aliphatic polyamide, especially a semi-crystalline aliphatic polyamide.

Advantageously, in this first variant, the polyamide of said tube is formed by a composition comprising predominantly a semi-crystalline aliphatic polyamide selected from PA6, PA610, PA612, PA1012, PA1010, PA11 and PA12, in particular PA11.

Advantageously in this first variant, said tube has been intended for transporting fuel such as gasoline, in particular alcohol-based gasoline, bio-gasoline or diesel, in particular bio-diesel.

Advantageously, in this first variant, the semi-crystalline aliphatic polyamide is selected from PA6, PA610, PA612, PA1012, PA1010, PA11 and PA12, in particular PA11, and said tube was intended to convey fuel such as gasoline, in particular alcohol-based gasoline, bio-gasoline or diesel, in particular bio-diesel.

In a second variant, said tube which was intended to convey a fluid for a motor vehicle is catalyzed single-layer which is then crushed, recompounded without the addition of catalyst.

In one embodiment of this second variant, the polyamide of said tube is an aliphatic or aromatic polyamide, in particular an aliphatic polyamide, especially a semi-crystalline aliphatic polyamide.

Advantageously, in this second variant, the polyamide of said tube is formed by a composition comprising predominantly a semi-crystalline aliphatic polyamide selected from PA6, PA610, PA612, PA1012, PA1010, PA11 and PA12, in particular PA11.

Advantageously in this second variant, said tube has been intended for transporting fuel such as gasoline, in particular alcohol-based gasoline, bio-gasoline or diesel, in particular bio-diesel.

Advantageously, in this second variant, the semi-crystalline aliphatic polyamide is selected from PA6, PA610, PA612, PA1012, PA1010, PA11 and PA12, in particular PA11, and said tube was intended to convey fuel such as gasoline, in particular alcohol-based gasoline, bio-gasoline or diesel, in particular bio-diesel.

In a third variant, said tube which was intended to convey a fluid for a motor vehicle is non-catalyzed multi-layer which is then crushed and recompounded with the addition of catalyst.

In one embodiment of this third variant, the polyamide of the predominant layer of said tube is an aliphatic or aromatic polyamide, in particular an aliphatic polyamide, especially a semi-crystalline aliphatic polyamide.

Advantageously, in this third variant, the polyamide of said tube is formed by a composition comprising predominantly a semi-crystalline aliphatic polyamide selected from PA6, PA610, PA612, PA1012, PA1010, PA11 and PA12, in particular PA11.

Advantageously in this third variant, said tube has been intended for transporting fuel such as gasoline, in particular alcohol-based gasoline, bio-gasoline or diesel, in particular bio-diesel.

Advantageously, in this third variant, the semi-crystalline aliphatic polyamide is selected from PA6, PA610, PA612, PA1012, PA1010, PA11 and PA12, in particular PA11, and said tube was intended to convey fuel such as gasoline, in particular alcohol-based gasoline, bio-gasoline or diesel, in particular bio-diesel.

In a fourth variant, said tube which was intended to convey a fluid for a motor vehicle is catalyzed multi-layer which is then crushed and recompounded without the addition of catalyst.

In one embodiment of this fourth variant, the polyamide of the predominant layer of said tube is an aliphatic or aromatic polyamide, in particular an aliphatic polyamide, especially a semi-crystalline aliphatic polyamide.

Advantageously, in this fourth variant, the polyamide of the predominant layer of said tube is formed by a composition comprising predominantly a semi-crystalline aliphatic polyamide selected from PA6, PA610, PA612, PA1012, PA1010, PA11 and PA12, in particular PA11.

Advantageously in this fourth variant, said tube has been intended for transporting fuel such as gasoline, in particular alcohol-based gasoline, bio-gasoline or diesel, in particular bio-diesel.

Advantageously, in this fourth variant, the semi-crystalline aliphatic polyamide is selected from PA6, PA610, PA612, PA1012, PA1010, PA11 and PA12, in particular PA11, and said tube was intended to convey fuel such as gasoline, in particular alcohol-based gasoline, bio-gasoline or diesel, in particular bio-diesel.

In a fifth variant, said tube which was intended to convey a fluid for a motor vehicle is a mixture of non-catalyzed single-layer and non-catalyzed multi-layer tube, said mixture then being crushed, recompounded with the addition of catalyst.

It would not be outside the scope of the invention if one of the single-layer and multi-layer tubes was catalyzed.

In one embodiment of this fifth variant, the polyamide of said single-layer tube and that of the predominant layer of said multi-layer tube are an aliphatic or aromatic polyamide, in particular an aliphatic polyamide, especially a semi-crystalline aliphatic polyamide.

Advantageously, in this fifth variant, the polyamide of said single-layer tube and that of the predominant layer of said multi-layer tube are formed by a composition comprising predominantly a semi-crystalline aliphatic polyamide selected from PA6, PA610, PA612, PA1012, PA1010, PA11 and PA12, in particular PA11.

Advantageously in this fifth variant, said tube has been intended for transporting fuel such as gasoline, in particular alcohol-based gasoline, bio-gasoline or diesel, in particular bio-diesel.

Advantageously, in this fifth variant, the semi-crystalline aliphatic polyamide is selected from PA6, PA610, PA612, PA1012, PA1010, PA11 and PA12, in particular PA11, and said tube was intended to convey fuel such as gasoline, in particular alcohol-based gasoline, bio-gasoline or diesel, in particular bio-diesel.

In a sixth variant, said tube which was intended to convey a fluid for a motor vehicle is a catalyzed single-layer and catalyzed multi-layer tube mixture, said mixture then being crushed and recompounded without the addition of catalyst. It would not be outside the scope of the invention if one of the single-layer and multi-layer tubes was non-catalyzed.

In one embodiment of this sixth variant, the polyamide of said single-layer tube and that of the predominant layer of said multi-layer tube are an aliphatic or aromatic polyamide, in particular an aliphatic polyamide, especially a semi-crystalline aliphatic polyamide.

Advantageously, in this sixth variant, the polyamide of said single-layer tube and that of the predominant layer of said multi-layer tube are formed by a composition comprising predominantly a semi-crystalline aliphatic polyamide selected from PA6, PA610, PA612, PA1012, PA1010, PA11 and PA12, in particular PA11.

Advantageously in this sixth variant, said tube has been intended for transporting fuel such as gasoline, in particular alcohol-based gasoline, bio-gasoline or diesel, in particular bio-diesel.

Advantageously, in this sixth variant, the semi-crystalline aliphatic polyamide is selected from PA6, PA610, PA612, PA1012, PA1010, PA11 and PA12, in particular PA11, and said tube was intended to convey fuel such as gasoline, in particular alcohol-based gasoline, bio-gasoline or diesel, in particular bio-diesel.

In a seventh variant, said tube which was intended to convey a fluid for a motor vehicle is a mixture of a single-layer and multi-layer tube, said mixture being formed by more than 50% of non-catalyzed tube and of less than 50% of catalyzed tube, said mixture then being crushed, recompounded without the addition of catalyst.

It would not be outside the scope of the invention if one of the single-layer and multi-layer tubes was non-catalyzed.

In one embodiment of this seventh variant, the polyamide of said single-layer tube and that of the predominant layer of said multi-layer tube are an aliphatic or aromatic polyamide, in particular an aliphatic polyamide, especially a semi-crystalline aliphatic polyamide.

Advantageously, in this seventh variant, the polyamide of said single-layer tube and that of the predominant layer of said multi-layer tube are formed by a composition comprising predominantly a semi-crystalline aliphatic polyamide selected from PA6, PA610, PA612, PA1012, PA1010, PA11 and PA12, in particular PA11.

Advantageously in this sixth variant, said tube has been intended for transporting fuel such as gasoline, in particular alcohol-based gasoline, bio-gasoline or diesel, in particular bio-diesel.

Advantageously, in this seventh variant, the semi-crystalline aliphatic polyamide is selected from PA6, PA610, PA612, PA1012, PA1010, PA11 and PA12, in particular PA11, and said tube was intended to convey fuel such as gasoline, in particular alcohol-based gasoline, bio-gasoline or diesel, in particular bio-diesel.

In one embodiment of one of the seven variants hereinbefore, the initial inherent viscosity of the polyamide of said tube before use as determined according to ISO 307:2007 in m-cresol at 20° C. is from 1.3 dl/g to 1.6 dl/g.

The polyamide of said tube has therefore never been used.

In one embodiment of one of the seven variants hereinbefore, the inherent viscosity of the polyamide of said used tube, before recycling as determined according to ISO 307:2007 in m-cresol at 20° C. is from 0.8 dl/g to 1.6 dl/g.

In one embodiment of one of the seven variants hereinbefore, the initial intrinsic viscosity of the polyamide of said tube after recycling, that is to say after crushing and recompounding with or without catalyst, as determined according to ISO 307:2007 in m-cresol at 20° C. is from 1.3 dl/g to 1.6 d/g.

Advantageously, the composition is degassed during compounding, even more advantageously, the degassing is located just after the melting zone of an extruder.

Advantageously, degassing is carried out during at least one compounding, even more advantageously the degassing is located just after the melting zone in an extruder.

In one embodiment, the degassing is weak, which means that the degassing is comprised from −50 mmHg to −150 mmHg.

In another embodiment, the degassing is strong, which means that the degassing is comprised from −550 mmHg to −750 mmHg.

In one embodiment of one of the seven variants hereinbefore, the inherent viscosity of the polyamide of said tube after recycling with degassing, that is to say after crushing and recompounding with or without catalyst, and degassing, as determined according to ISO 307:2007 in m-cresol at 20° C. is from 1.3 dl/g to 1.6 dl/g.

Advantageously, said tube that has been intended for transporting fluid for a motor vehicle is single-layer.

Regarding the Catalyst

The term “catalyst” denotes a polycondensation catalyst such as a mineral or organic acid.

Advantageously, the proportion by weight of catalyst is comprised from around 50 ppm to about 5000 ppm, in particular from about 100 to about 3000 ppm relative to the total weight of the composition.

Advantageously, the catalyst is chosen from phosphoric acid (H3PO4), phosphorous acid (H3PO3), hypophosphorous acid (H3PO2), or a mixture thereof.

Regarding the Method

According to another aspect, the present invention relates to a method for manufacturing a single-layer tubular structure as defined hereinbefore, comprising a step of crushing and at least one step of compounding at least one single-layer and/or multi-layer tube that was intended to convey fluids for a motor vehicle.

The tube to be reused or otherwise recycled (single-layer and/or multi-layer) which may or may not be catalyzed is therefore removed from the motor vehicle and first is crushed and then this crushed tube is recompounded, that is to say that the crushed material is again inserted at least once into an extruder, especially of the twin-screw co-rotating type, or of the co-kneader type (Buss), where it is mixed again by melting, with or without the addition of at least one catalyst.

If the material to be recycled must be mixed with unused virgin material, then the latter is either crushed beforehand if it originates from a tube and mixed with the crushed material to be recycled in order to be recompounded together, or the crushed material of the tube to be reused (or otherwise recycled) and granules (or crushed material) of unused virgin material are previously mixed in order to be recompounded together.

Optionally, the tube to be reused, catalyzed or not and removed from the motor vehicle, undergoes a washing and/or cleaning step before crushing.

Optionally, the crushed tube undergoes a washing and/or cleaning step after crushing.

Optionally, the tube to be reused, catalyzed or not and removed from the motor vehicle, undergoes a washing and/or cleaning step before crushing then it is crushed and it optionally undergoes, before recompounding, a washing and/or cleaning step after crushing.

The cleaning step can be performed, for example, under vacuum.

The molten material comes out of the extruder in strands that are cooled and cut into granules.

In one embodiment, at least one recompounding step is carried out with the addition of a catalyst.

Advantageously, said at least one single-layer and/or multi-layer tube is non-catalyzed.

In another embodiment, at least one recompounding step is carried out with the addition of a catalyst and said at least one single-layer and/or multi-layer tube is non-catalyzed.

Advantageously, said at least one tube is single-layer.

Advantageously, said at least one tube is multi-layer.

Advantageously, said at least one single-layer and/or multi-layer tube is a mixture formed by more than 50% of non-catalyzed tube and by less than 50% of catalyzed tube.

In another embodiment, said recompounding step(s) is/are carried out without the addition of a catalyst.

Advantageously, said at least one single-layer and/or multi-layer tube is catalyzed.

Advantageously, said at least one tube is single-layer.

Advantageously, said at least one tube is multi-layer.

Advantageously, said at least one single-layer and/or multi-layer tube is a mixture formed by more than 50% of non-catalyzed tube and by less than 50% of catalyzed tube.

Advantageously, the composition is degassed during compounding.

In one embodiment, the degassing is weak, which means that the degassing is comprised from −50 mmHg to −150 mmHg.

For example, it is carried out according to the following protocol A: the recrushed tube is recompounded on a Coperion/Werner 40-mm twin-screw extruder with a setpoint of 70 kg/h, 300 rpm, 270° C., with a degassing of −100 mmHg.

In another embodiment, the degassing is strong, which means that the degassing is comprised from −550 mmHg to −750 mmHg.

For example, it is carried out according to the following protocol B: the recrushed tube is recompounded on a Coperion/Werner 40-mm twin-screw extruder with a setpoint of 70 kg/h, 300 rpm, 270° C., with a strong degassing of −660 mmHg.

Advantageously, the degassing is located just after the melting zone in the extruder.

If the composition of the layer (1) is formed by less than 100% recycled material, it is then necessary to add a polyamide (identical or different) of non-recycled origin to the material to be recycled, and this can be done when passing through the extruder at least once or else by prior compounding of the granules hereinbefore obtained with said polyamide of non-recycled origin.

In another embodiment, at least one recompounding step is carried out under weak degassing.

In another embodiment, at least one recompounding step is carried out under strong degassing.

In one embodiment, a step of extruding the crushed and recompounded tube is carried out in order to obtain the tubular structure.

In a first variant, the extrusion step is carried out after the recompounding with or without the addition of catalyst.

In a second variant, the extrusion step is carried out after the recompounding with or without the addition of catalyst under degassing, in particular under weak or strong degassing, more particularly under strong degassing.

Advantageously, the method according to the invention comprises the following steps:
1) Crushing a catalyzed or non-catalyzed used single-layer and/or multi-layer tube, and optionally adding granules (or crushed material) of unused virgin material,
2) recompounding said crushed tube with the addition of a catalyst if said tube is non-catalyzed, or without the addition of catalyst if said tube is catalyzed in an extruder,
3) optionally adding a polyamide which may be catalyzed or non-catalyzed, in particular catalyzed during recompounding in the extruder, in order to have a proportion of recycled polyamide of at least 30%, in particular of at least 50% relative to the total amount of polyamide,
4) optionally degassing, in particular weak or strong degassing, in particular strong degassing, during recompounding,
5) cooling the strand at the outlet of the extruder and cutting into granules,
6) optionally recompounding said granules cut in an extruder with a catalyzed polyamide in the extruder in order to have a proportion of recycled polyamide of at least 30%, in particular at least 50% relative to the total amount of polyamide if step 4) is absent,
7) optionally cooling the strand at the outlet of the extruder and cutting into granules.

All the technical features detailed hereinbefore for both the layer (1) and the recycled tube are valid for the method.

Regarding the Use

According to another aspect, the present invention relates to the use of at least one single-layer and/or multi-layer tube that was intended to convey fluids for a motor vehicle, in particular as defined hereinbefore, said at least one single-layer and/or multi-layer tube being formed by a composition that predominantly comprises at least one catalyzed or non-catalyzed polyamide, said at least one single-layer and/or multi-layer tube having been crushed and then at least recompounded with or without the addition of at least one catalyst in order to be able to be recycled,
a simple one-off crushing being excluded,
for the preparation of a single-layer tubular structure intended to convey fluids for a motor vehicle, in particular air, oil, water, a urea solution, a glycol-based cooling liquid, or a fuel such as gasoline, in particular alcohol-based gasoline, bio-gasoline or diesel, in particular bio-diesel, or hydrogen, formed by a layer (1) formed by a composition comprising predominantly at least one catalyzed semi-crystalline aliphatic polyamide, said composition being formed by at least 30% by weight, in particular at least 50% of recycled material originating from said single-layer and/or multi-layer tube.

All the technical features detailed hereinbefore for both the layer (1) and the recycled tube and the method are valid for the use.

### EXAMPLES

The following resins were used in the various compositions of the invention:

Catalyzed PA11: Polyamide 11 of Mn (number-average molecular mass) 29000. The melting temperature is 190° C.; its melting enthalpy is 56 kJ/m2. The composition of this PA11 comprises 0.25% (+/−0.05%) of H3PO4.

Non-catalyzed PA12: Polyamide 12 of Mn (number-average molecular mass) 35000. The melting temperature is 178° C.; its melting enthalpy is 54 kJ/m2

The melting temperature and the melting enthalpy were determined according to ISO standard 11357-3:2013.

The following additives, plasticizers and impact modifiers were used in the compositions of the invention:
stabilizer: stabilizer consisting of 80% of phenol Lowinox 44625 from Great Lakes, 20% of phosphite Irgafos 168 from Ciba
BBSA: BBSA (butyl benzene sulfonamide) plasticizer,
Imod=generically refers to a polyolefin type impact modifier or the like, such as among others PEBAs (polyether block amide), core-shells, silicons . . .
Imod1: refers to an EPR functionalized by a reactive group with anhydride function (at 0.5-1% by mass), of MFI 9 (at 230° C., below) 10 kg, of Exxellor VA1801 type from Exxon.

The following compositions were used to produce the tubes according to the invention:

In the entire description, all the percentages are given in weight.

In the case of the compositions named “recy”, and “recy2” used for the layer (1) of the tubes of the invention or counterexample tubes, protocols to simulate an aged tube have been used:

The inherent viscosity according to ISO 307:2007 in m-cresol at 20° C. was determined initially on the tubes before use

The tube is aged according to a standard general protocol that is easily reproducible, which consists in immersing said single-layer tubular structure in FAM-B alcohol-based gasoline and in heating the assembly to 60° C. for 500 h, 1000 h, 1500 h, 2000 h and 5000 hours, then in recovering the tube and analyzing it.

This standard aging is representative of what the gasoline conveying tubes undergo in 10 years of service in a vehicle in a hot engine.

The FAM-B alcohol-based gasoline is disclosed in standard DIN 51604-1:1982, DIN 51604-2:1984 and DIN 51604-3:1984.

In short, FAM-A alcohol-based gasoline is first prepared with a mixture of 50% toluene, 30% isooctane, 15% di-isobutylene and 5% ethanol then FAM-B is prepared by mixing 84.5% FAM A with 15% methanol and 0.5% water.

In total, FAM-B consists of 42.3% toluene, 25.4% isooctane, 12.7% di-isobutylene, 4.2% ethanol, 15% methanol and 0.5% water.

After each aging, the inherent viscosity of the tube is determined then the tube is crushed and treated according to two protocols:

Protocol A: After aging, the crushed tube is recompounded on a Coperion/Werner 40-mm twin-screw extruder with a setpoint of 70 kg/h, 300 rpm, 270° C., with or without the addition of catalyst.

The inherent viscosity of the tube is then determined.

Protocol B: After aging, the crushed tube is recompounded on a Coperion/Werner 40-mm twin-screw extruder, with a set-point of 70 kg/h, 300 rpm, 270° C., with or without the addition of catalyst and with a strong degassing of −660 mmHg.

The inherent viscosity of the tube is then determined.

The various compositions used for the preparation of the tubes of the invention are as follows:
PA11PL cat=catalyzed PA11+7% BBSA+1% stabilizer
PA12PL=non-catalyzed PA12+12% BBSA+1% stabilizer
PA12PL cat=catalyzed PA12+12% BBSA+1% stabilizer
PA11PL cat-recy=PA11PL cat tube aged according to general protocol, recrushed only.
PA11PL-recy2=PA11PL cat tube aged according to general protocol, recrushed, recompounded according to protocol A, without the addition of catalyst during this recompounding.
PA12PL-recy2=PA12PL tube aged according to general protocol, recrushed, recompounded according to protocol A, without the addition of catalyst during this recompounding.
PA12PL-recy2bis=PA12PL tube aged according to general protocol, recrushed, recompounded according to protocol A, with the addition of catalyst during this recompounding.

These compositions are manufactured by conventional compounding in a co-rotating twin screw extruder of Coperion 40 type, at 300 rpm, at 270° C. (or at 300° C. when the ingredients have a melting point higher than 260° C.).

Single-Layer Tubes of the Invention:

the tubes have a dimension of 8*1 mm

Preparation of Single-Layer Structures (Tubes):

The single-layer structures are produced by extrusion. An industrial Maillefer multilayer extrusion line is used, equipped with 5 extruders, connected to a multilayer extrusion head with spiral mandrels.

The screws used are extrusion monoscrews having screw profiles adapted to polyamides. In addition to the 5 extruders and the extrusion head, the extrusion line comprises:
a die-punch assembly, located at the end of the extrusion head; the interior diameter of the die and the exterior diameter of the punch are selected according to the structure to be produced and the materials of which it is composed, as well as the dimensions of the tube and the line speed;
a vacuum tank with an adjustable vacuum level. In this tank water circulates generally maintained at 20° C., in which a gauge is submerged making it possible to shape the tube to its final dimensions. The diameter of the gauge is adapted to the dimensions of the tube to be produced, typically from 8.5 to 10 mm for a tube with an external diameter of 8 mm and a thickness of 1 mm;
a succession of cooling tanks in which water is maintained at around 20° C., allowing the tube to be cooled along the path from the head to the drawing bench;
a diameter meter;
a drawing bench.

The configuration with 5 extruders is used to produce the tubes ranging from 2 layers to 5 layers, as well as for single-layer tubes.

Before the tests, in order to ensure the best properties for the tube and good extrusion quality, it is verified that the extruded materials have a residual moisture content before extrusion of less than 0.08%. Otherwise, an additional step of drying the material before the tests, generally in a vacuum dryer, is carried out overnight at 80° C.

The tubes, which satisfy the features described in the present patent application, were removed, after stabilization of the extrusion parameters, the dimensions of the tubes in question no longer changing over time. The diameter is controlled by a laser diameter meter installed at the end of the line.

The line speed is typically 20 m/min. It generally ranges from 5 to 100 m/min.

The screw speed of the extruders depends on the thickness of the layer and on the diameter of the screw as is known to those skilled in the art.

In general, the temperatures of the extruders and of the tools (head and connector) must be adjusted so as to be sufficiently higher than the melting temperature of the compositions in question, so that they remain in the molten state, thus preventing them from solidifying and jamming the machine.

The single-layer tubes manufactured by extrusion hereinbefore were then assessed according to several criteria:

The results are given in Table 1.

TABLE 1

| | | | | | | | | Inherent |
|---|---|---|---|---|---|---|---|---|
| | | | | | | | | viscosity |
| | | | | | | | | in dl/g |
| | | | | | | | | after |
| | | Inherent viscosity in dl/g at t (h) | | | | | | recycling |
| Example | Structure | 0 | 500 | 1000 | 1500 | 2000 | 5000 | — |
| Ex1 | Single-layer PA11PL cat | 1.4 | 1.5 | 1.7 | 1.75 | 1.6 | 1.2 | — |
| Ex2 | Single-layer PA11PL-recy | 1.4 | 1.5 | 1.7 | 1.75 | 1.6 | 1.2 | 1.2 |
| Ex3 | Single-layer PA11PL-recy2 | 1.4 | 1.5 | 1.7 | 1.75 | 1.6 | 1.2 | 1.4 |
| Ex4 | Monolayer PA12PL | 1.48 | 1.48 | 1.48 | 1.4 | 1.3 | 1.1 | — |
| Ex5 | Single-layer PA12PL-recy2 | | | | | | | 1.15 |
| Ex6 | Single-layer PA12PL-recy2bis | | | | | | | 1.45 |
| Ex7 | Single-layer PA12PL-cat | 1.45 | 1.53 | 1.75 | 1.8 | 1.6 | 1.15 | |
| Ex8 | Single-layer PA12PL-cat-recy2 | | | | | | | 1.4 |

The inherent viscosity was determined according to ISO 307:2007 in m-cresol at 20° C. over 10 tubes for each example.

Table 1 shows that the crushing followed by recompounding without the addition of catalyst fora catalyzed and aged polyamide (PA11PI-cat and PA12-PL-cat) makes it possible to regain the original inherent viscosity and thus the qualities of the original tube while a simple crushing does not make it possible to regain the original inherent viscosity.

It also shows that crushing followed by recompounding without the addition of catalyst for a non-catalyzed and aged polyamide (PA11PI-cat) does not make it possible to regain the original inherent viscosity and thus the qualities of the original tube.

1. A single-layer tubular structure intended to convey fluids for a motor vehicle, formed by a layer formed by a composition comprising at least one catalyzed semi-crystalline aliphatic polyamide, said composition being formed by at least 30% by weight of recycled material originating from at least one single-layer and/or multi-layer tube that was intended to convey fluids for a motor vehicle, said at least one single-layer and/or multi-layer tube being formed by a composition that predominantly comprises at least one catalyzed or non-catalyzed polyamide,
said at least one single-layer and/or multi-layer tube having been crushed and then at least recompounded with or without the addition of at least one catalyst in order to be able to be recycled,
a simple one-off crushing being excluded.

2. The single-layer tubular structure according to claim 1, wherein said composition is formed by at least 50% of recycled material originating from a single-layer and/or multi-layer tube that was intended to convey fluids for a motor vehicle.

3. The single-layer tubular structure according to claim 1, wherein said at least one single-layer and/or multi-layer tube is formed by a composition that predominantly comprises at least one catalyzed polyamide, said at least one single-layer and/or multi-layer tube having been crushed and then at least recompounded without the addition of a catalyst in order to be able to be recycled.

4. The single-layer tubular structure according to claim 1, wherein said at least one single-layer and/or multi-layer tube is formed by a composition that predominantly comprises at least one catalyzed polyamide, said at least one single-layer and/or multi-layer tube having been crushed and then at least recompounded with the addition of a catalyst in order to be able to be recycled.

5. The single-layer tubular structure according to claim 1, wherein said composition of the layer 44-lacks plasticizer and/or impact modifier.

6. The single-layer tubular structure according to claim 1, wherein said composition of the layer comprises at least one compound selected from plasticizer, an impact modifier and an additive.

7. The single-layer tubular structure according to claim 1, wherein the fluid conveyed by said at least one single-layer and/or multi-layer tube is the same as that of said single-layer tubular structure.

8. The single-layer tubular structure according to claim 1, wherein the fluid conveyed by said single-layer and/or multi-layer tube is different from that of said single-layer tubular structure.

9. The single-layer tubular structure according to claim 1, wherein said at least one tube is a single-layer tube.

10. The single-layer tubular structure according to claim 1, wherein said at least one tube is a multi-layer tube

11. The single-layer tubular structure according to claim 1, wherein the Tm of the predominant semi-crystalline aliphatic polyamide of the layer is ≤225° C. as determined by DSC according to ISO standard 11357-3:2013, at a heating rate of 20K/min.

12. The single-layer tubular structure according to claim 1, wherein the predominant semi-crystalline aliphatic polyamide of the layer has a crystallization enthalpy ≥25 J/g, as determined by DSC according to ISO standard 11357-3:2013, at a heating rate of 20K/min.

13. A method for manufacturing a single-layer tubular structure as defined in claim 1, comprising a step of crushing and at least one step of recompounding at least one single-layer and/or multi-layer tube that was intended to convey fluids for a motor vehicle defined in claim 1.

14. The method according to claim 13, wherein at least one recompounding step is carried out with the addition of a catalyst.

15. The method according to claim 14, wherein said at least one single-layer and/or multi-layer tube is non-catalyzed.

16. The method according to claim 14, wherein said at least one single-layer and/or multi-layer tube is a mixture formed by more than 50% of non-catalyzed tube and less than 50% of catalyzed tube.

17. The method according to claim 13, wherein said recompounding step(s) is/are carried out without the addition of a catalyst.

18. The method according to claim 17, wherein said at least one single-layer and/or multi-layer tube is catalyzed.

19. The method according to claim 13, wherein at least one recompounding step is carried out under strong degassing.

20. The method according to claim 13, wherein a step of extruding the crushed and recompounded tube is carried out in order to obtain the tubular structure.

21. A method comprising using at least one single-layer and/or multi-layer tube that was intended to convey fluids for a motor vehicle as defined in claim 1, for the preparation of a single-layer tubular structure intended to convey fluids for a motor vehicle.
